(19) United States
(12) Patent Application Publication
(10) Pub. No.: US 2011/0057961 A1
(43) Pub. Date: Mar. 10, 2011

(54) Liquid Crystal Display Device and Backlight Control Method

(75) Inventors: Yasutaka Tsuru, Yokohama (JP); Yuya Ogi, Yokohama (JP); Kazuhiko Tanaka, Fujisawa (JP)

(73) Assignee: Hitachi Consumer Electronics Co., Ltd., Tokyo (JP)

(21) Appl. No.: 12/785,242

(22) Filed: May 21, 2010

(30) Foreign Application Priority Data
Sep. 7, 2009 (JP) 2009-205844

(51) Int. Cl. G09G 5/10; G09G 3/36

(52) U.S. Cl. 345/690; 345/89

(57) ABSTRACT

In a liquid crystal device, an in-region gradation value detection section detects gradation levels of input video signals on every sub-region, removing gradation levels of pixels within a predetermined upper range (m %) from the brightest gradation level in the sub-region to detect the maximum in-region gradation level Pa. A boundary gradation value detecting section removes gradation levels for pixels within a predetermined upper range (n %) from the brightest gradation level for pixel groups belonging to the region boundary portion in the sub-region to detect the maximum boundary gradation level Pb. A backlight control value deciding section selects higher one of the level Pa and the level Pb as the maximum gradation level Pc in the sub-region, and decides a backlight control value K based on the ratio between the level Pc and the upper limit value Pmax of the gradation level.

### CLAIM OF PRIORITY

The present application claims priority from Japanese patent application serial No. JP 2009-205844, filed on Sep. 7, 2009, the content of which is hereby incorporated by reference into this application.

### BACKGROUND OF THE INVENTION

(1) Field of the Invention

The present invention concerns a liquid crystal display device having a backlight for illuminating a liquid crystal panel that displays images at the back thereof and adjusting the luminance of the backlight in accordance with video signals to be displayed, and a backlight control method.

(2) Description of the Related Art

Different from an emissive type display device such as a CRT (cathode ray tube) or a plasma display panel, a liquid crystal display device has a non-light emitting liquid crystal panel (transparent light modulator) and a backlight for illuminating the panel at the back surface thereof. Usually, the backlight is caused to emit a light at a predetermined brightness irrespective of video signals and an image of a desired bright is displayed by controlling the light transmittance of a liquid crystal panel in accordance with the brightness of the video signals. Accordingly, the electric power of a backlight light source is not decreased even for dark images and consumed constantly to make the power efficiency poor. As a countermeasure, it has been proposed a technique of making the brightness of the backlight (hereinafter also expressed as luminance) variable and controlling the gradation level of the liquid crystal panel and the brightness of the backlight in accordance with the level of the input video signals, thereby decreasing the power consumption and improving the image quality.

For example, in a liquid crystal display device described in Example 1 of JP-A No. 2008-15430, a backlight is divided into a plurality of regions (light source blocks), a brightest gradation level in the frame is detected on every R, G, B of input video signals in each region, the gradation level of the input video signals is converted such that the gradation level is at a level identical with the upper limit value of the gradation level, and the backlight is turned on and off at a duty cycle corresponding to the ratio of the brightest gradation level to the upper limit value of the gradation level during lighting period of the backlight. Further, in Example 2 of JP-A No. 2008-15430, an average value for gradation levels within a predetermined range containing the brightest gradation level in the frame is detected, the gradation level of the input video signals is converted such that the average value is at a level identical with the upper limit value of the gradation level, and the backlight is turned on and off at a duty corresponding to the ratio of the average value to the upper limit value of the gradation level.

### SUMMARY OF THE INVENTION

According to the technique described in Example 1 of JP-A No. 2008-15430, when the brightest gradation level Ppeak is lower than the upper limit value Pmax of the gradation level, and the brightness of the backlight is lowered to a value obtained by multiplying the ratio Ppeak/Pmax to decrease the consumption power by so much. Further, according to the technique described in Example 2 of the Patent Document 1 (referred to as an average value method), since the detected average value Pav is lowered to less than the brightest gradation level Ppeak, and the brightness of the backlight is lowered to a value obtained by multiplying the ratio Pav/Pmax of the average value Pav and the upper limit value Pmax of the gradation level, the power consumption is further decreased.

However, in a case of using the average value method described above, since the gradation level of the input video signals is converted such that the average value Pav is at a level identical with the upper limit value Pmax of the gradation level, the gradation level is clipped at the upper limit value Pmax for the input video signal at the gradation level brighter than the average value Pay. As a result, in the clipped pixel, an inherent brightness of the images can no more be expressed. The phenomenon is hereinafter referred to as “deterioration of gradation”.

The deterioration of gradation causes deterioration of the image quality and the prominence of degradation (visual recognizability) is different depending on the generation position within the screen. In a backlight divided into a plurality of regions, deterioration of gradation generated in a central portion of the region is not so visually remarkable. However, when the deterioration of gradation is generated in a region boundary portion, continuity of brightness with an adjacent region cannot be kept and this tends to be visually recognized as the luminance step.

FIG. 6 is a view for explaining the generation of the luminance step due to the deterioration of gradation. A screen 600 is divided into regions 601 and 602 in which reference 603 denotes a boundary line. It is assumed that a bright portion 604 and a dark portion 605 are present on the screen and the brightness on the screen changes smoothly. In this case, change of the luminance along a straight line 606 traversing the screen is shown as a luminance distribution 610. In the region 601, deterioration of gradation 613 is generated in a bright portion 604 by a luminance clip level 611 and gradation level loss 614 is generated near the boundary line 603 by the luminance clip level 612 in the region 602. In each portions of the deterioration of gradation, the luminance is lowered to less than the usual value. The deterioration of gradation 613 present in the central portion of the region cause no luminance step to the surrounding and is less recognized visually. On the contrary, the deterioration of gradation 614 present in adjacent with the boundary line 603 generates a luminance step 615 relative to the adjacent region 601 and is recognized visually, for example, like a shadow 607. As a result, this results in a nonnegligible deterioration of image quality with a view point of visual sense.

The present invention intends to provide a liquid crystal display device for decreasing the power consumption of a backlight while suppressing generation of a luminance step in a region boundary and a method of controlling the backlight.

The present invention provides a liquid crystal display device having a liquid crystal panel for controlling the transmittance of pixels in accordance with the gradation level of input video signals and a backlight for illuminating the liquid crystal panel at the back thereto, in which the liquid crystal panel is divided for the pixels on the panel into sub-regions comprising a plurality of pixel groups, and the backlight includes a plurality of light source blocks corresponding to the sub-regions and has; an in-region gradation value detection section which detects the gradation level of input video signals on every sub-region, removes gradation levels of pixels within a predetermined upper range (m %) from the brightest gradation level in the sub-region and detects the maximum in-region gradation level Pa, a boundary gradation value detection section which removes gradation levels of pixels within a predetermined upper range (n %) from the brightest gradation level and detects the maximum boundary gradation level Pb for the pixel groups belonging to the region boundary portion in the sub-region, a backlight control value deciding section which selects higher one of the in-region maximum gradation level Pa and the maximum boundary gradation level Pb as a maximum gradation level Pc for the sub-region, and decides the backlight control value K based on the ratio between the maximum gradation level Pc and the upper limit value Pmax of the gradation level, and a backlight control section which controls lighting at a backlight luminance based on the backlight control value K to the light source block for illuminating sub-region.

The present invention provides a method of controlling a backlight of a liquid crystal display device having a backlight for illuminating the liquid crystal panel at the back thereof, in which the liquid crystal panel is divided for the pixels on the panel is divided for the pixels on the panel into sub-regions comprising a plurality of pixel groups, and the backlight has a plurality of light source blocks corresponding to the sub-regions, the method including; detecting gradation levels of input video signals on every sub-region, removing the gradation levels for pixels within a predetermined upper range (m %) from the brightest gradation level in the sub-regions, and detecting the in-region maximum gradation level Pa, removing gradation levels for the pixels within a predetermined upper range (n %) from the brightest gradation level for the pixel groups belonging to the region boundary portion in the sub-region and detecting the maximum boundary gradation level Pb, selecting a higher one of the maximum in-region gradation level Pa and the maximum boundary gradation level Pb as the maximum gradation level Pc in the region, deciding the backlight control value K based on the ratio between the maximum gradation level Pc and the upper limit value Pmax of the gradation level, and controlling lighting at a backlight luminance based on the backlight control value K to the light source block for illuminates the sub-region.

The present invention can provide a liquid crystal display device capable of greatly reducing the power consumption of a backlight while suppressing the deterioration of image quality caused by the luminance step, and a method of controlling the backlight.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a first embodiment of a liquid crystal display device according to the invention;

FIG. 2 is a view showing division of a region on a display screen;

FIG. 3 is a view showing a region boundary portion of a sub-region;

FIG. 4 is a flow chart showing a method of deciding a backlight control value;

FIG. 5A is a view showing an example of a histogram in the region;

FIG. 5B is a view showing an example of a histogram in the boundary;

FIG. 6 is a view for explaining the generation of a luminance step caused by deterioration of gradation;

FIG. 7 is a block diagram showing a second embodiment of the liquid crystal display device according to the invention;

FIG. 8 is a block diagram showing a third embodiment of the liquid crystal display device according to the invention;

FIG. 9 is a view showing an example of a constitution of a light source block; and

FIG. 10 is a view showing an example of a constitution of an optical guide plate.

### DETAILED DESCRIPTION OF THE EMBODIMENT

Preferred embodiments of the invention are to be described with reference to the drawings.

### Embodiment 1

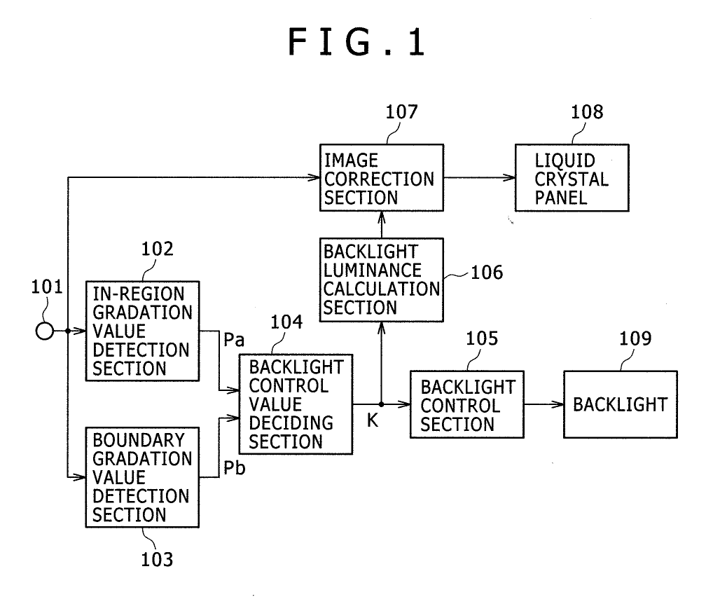

FIG. 1 is a block diagram showing a first embodiment of a liquid crystal display device according to the invention. The liquid crystal display device has an image input section 101, an in-region gradation value detection section 102, a boundary gradation value detection section 103, a backlight control value deciding section 104, a backlight control section 105, a backlight luminance calculation section 106, an image correction section 107, a liquid crystal panel 108, and a backlight 109. The liquid crystal panel 108 controls the transmittance of pixels in accordance with the gradation levels of input video signals and the backlight 109 illuminates the liquid crystal panel 108 at the back thereof. The backlight 109 has a plurality of light source blocks each comprising LED, etc. and respective light source blocks can be lit at different brightness (backlight luminance).

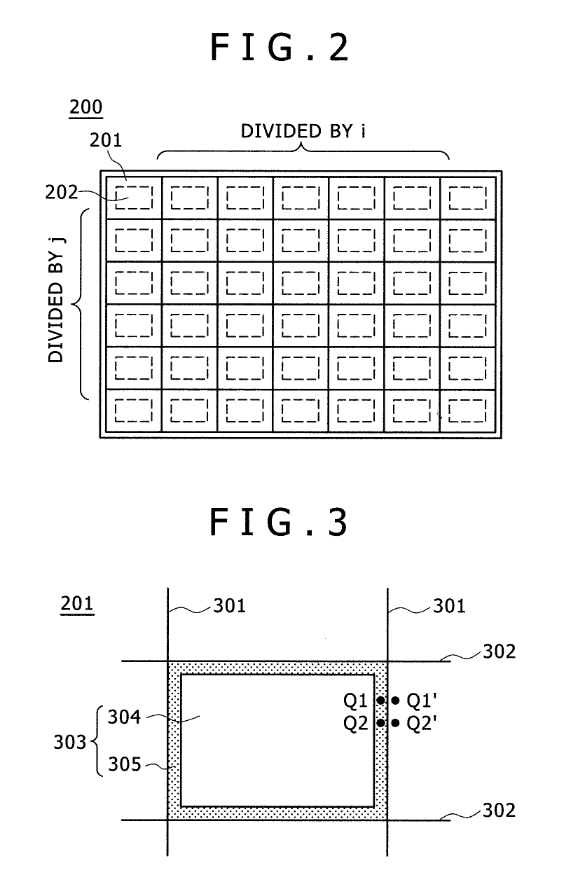

At first, division of the region on the screen of the liquid crystal panel 108 is to be described. FIG. 2 is a view showing the division of the region on the display screen. Pixels on the display screen 200 are divided into sub-regions 201 each comprising a plurality of pixel groups. In this embodiment, the screen is divided by the number of i in the horizontal direction of the screen and divided by the number of j in the vertical direction of the screen and divided into rectangular sub-regions 201 by the number of i×j. Each sub-region 201 has a light source block 202 and each light source blocks 202 can be controlled for the brightness independently. It can also be configured such that one sub-region 201 is illuminated by a plurality of light source blocks 202.

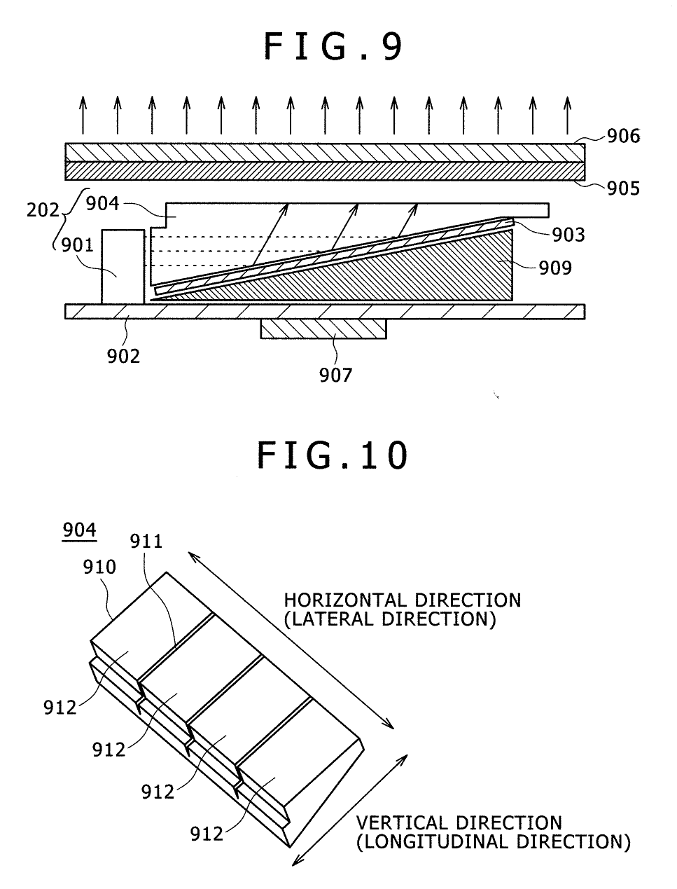

FIG. 9 is a view showing an example of a configuration of each light source block 202. In each of the light source blocks 202, a light emitting diode (LED) 901 or the like as a primary light source is mounted on one surface of an LED driving substrate 902 (surface on the side of a liquid crystal panel 906). An LED driver 907 for supplying a driving current to the LED 901 is mounted to the other surface of the LED driving substrate 902, and the driving current supplied from the LED driver 907 to the LED 901 is controlled by the backlight control section 105. The LED 901 emits, for example, a white light and a so-called side view type LED of emitting a light in the direction horizontal to the electrode surface of the LED (identical with the direction parallel to the main plane of LED driving circuit 902 in this embodiment) is used.

An optical guide plate 904 for guiding an emission light from the LED 901 (shown by dotted arrows in FIG. 9) to the frontal side (on the side of the liquid crystal panel) is disposed on the light emission side of the LED 901. A plurality of LEDs 901 (for example, by the number of three) are used to one optical guide plate 904 and a plurality of LED 901 are arranged in one row in a direction perpendicular to the drawing sheet in this embodiment. Further, a reflection sheet 903 for efficiently reflecting the emission light incident from the LED 901 to the optical guide plate 904 to the frontal side is disposed at the back of the optical guide plate 904. Further, a white support member 909 for reflecting the light is disposed in a space between the reflection sheet 903 and the LED driving substrate 902 and the support member 909 supports the reflection sheet 903 and the optical guide plate 904 at the back thereof.

The cross section of the optical guide plate 904 in the direction vertical to the liquid crystal panel 906 (left to right direction of the sheet in FIG. 9) has a wedge-like shape in which the thickness is gradually reduced from the incident end face where the light is incident to the top end opposing to the incident end face as shown in FIG. 9. Further, the reflection sheet 903 is disposed at the back of the optical guide plate 904. Accordingly, the emission light from the LED 901 incident from the optical guide plate 904 is deflected upward by the wedge shape of the optical guide plate 904 described above and the reflective effect of the reflection sheet 903 in the inside of the optical guide plate 904 (in the direction toward the liquid crystal panel 906). Further, by the effect of a diffusion reflection pattern formed at the bottom (surface on the side of the reflection sheet 903) or the light emission surface (surface on the side of the liquid crystal panel 906), the incident light is emitted as a planar light at a substantially uniform luminance level upward (in the direction on the side of the liquid crystal panel 906), for example, as shown by dotted arrows in FIG. 9.

The diffusion plate 905 diffuses the light emitted from the optical guide plate 904 into a further uniform planar light in view of the space and emits the same to the liquid crystal panel 906. The liquid crystal panel 906 is controlled for the light transmittance on every pixel based on the input video signals and modifies the light from the diffusion plate 905 in view of the space to form images. Thus, an image light shown by arrows directing upward of the sheet in the drawing is outputted to the frontal side of the liquid crystal display device.

While LED that emits a white light is used as the LED 101 in this embodiment, LED is not restricted thereto and, for example, a set of three LEDs emitting lights of red, blue, green three colors respectively may be used in plurality.

The optical source blocks 202 having the structure as described above are arranged in plurality in a 2-dimensional manner, i.e., in the horizontal and vertical directions of the screen at the back of the liquid crystal panel. Then, the brightness of the sub-regions 201 can be controlled independently by individually controlling LEDs 101 (a set of three in this embodiment) disposed to each of the optical source blocks 202.

FIG. 10 is a view showing an example of the configuration of the optical guide plate 904. An optical guide plate may be used to one light source block 202 but a plurality (by the number of four in FIG. 10) of optical guide plates may be joined integrally into a horizontal direction of the screen (lateral direction, identical with the direction of depth in FIG. 9), for example, as shown in FIG. 10 and one integral type optical guide plate 910 may be used to the four light source blocks 202. By arranging the plurality of integral type optical guide plates 910 in the horizontal direction and the vertical direction of the screen, an optical guide plate covering the entire surface of the liquid crystal panel is formed. In this case, grooves 911 extending in the vertical direction of the screen are formed in the integral type optical guide plate 910, by which the integral optical guide plate 910 is divided into a plurality of optical guide plate blocks 912 each corresponding to the light source blocks 202. On the contrary, a plurality of optical guide plates may be joined in the vertical direction of the screen to be integrated though this is not illustrated.

FIG. 3 is a view showing the region boundary portion in each of the sub-regions on the display screen. The sub-region 201 is surrounded with boundary lines 301 in the vertical direction and boundary lines 302 in the lateral direction. Then, the inside of the sub-region is divided into a central portion 304 apart from the boundary line and a region boundary portion 305 adjacent with the boundary line (hereinafter also referred to simply as the boundary portion). The boundary portion 305 is a frame-like region contained within a width, for example, of 1 to 2 pixels from each boundary line to the inside of the region. Further, the region including the central portion 304 and the boundary portion 305 is referred to as an in-region 303.

Then, operation for each of the portions is to be described. The in-region gradation value detection section 102 detects the gradation level of input video signals for the pixel groups belonging to the in-region 303 on every plural sub-regions 201 of the liquid crystal panel, and prepares an in-region histogram of the gradation level (frequency table) based on the result of the detection. Then, gradation levels for the pixels within a predetermined upper range (m %) from the brightest gradation level in the sub-region 201 are removed and the brightest gradation level among the remaining gradation levels is determined as the maximum in-region gradation level Pa.

The boundary gradation value detection section 103 detects the gradation level of input video signals for the pixel groups belonging to the boundary portion 305 in the sub-region on every plurality of sub-regions 201 of the liquid crystal panel and prepares a boundary portion histogram (frequency table) of the gradation level based on the result of detection. Then, gradation levels for the pixels within a predetermined upper range (n %) from brightest gradation levels in the boundary portion 305 are removed and the brightest gradation level among the remaining gradation levels is determined as the maximum boundary gradation level Pb.

The backlight control value deciding section 104 is a control data calculation section that gives a control data corresponding to each of the light source blocks 202 to the backlight control section 105, and compares the maximum in-region gradation level Pa detected by the in-region gradation value detection section 102 with the maximum boundary gradation level Pd detected by the boundary gradation value detection section 103, and decides a higher gradation level of them as the maximum gradation level Pc of the sub-region 201. Then, the backlight control value K to the sub-region 201 is determined based on the ratio between the decided maximum gradation level Pc and the upper limit value Pmax of the gradation level.

K=Pc/Pmax (K≦1)

Further, the luminance B of the backlight is lowered based on the backlight control value K as:

B=K×Bmax (Bmax is the maximum luminance of the backlight)

to decrease the power consumption of the backlight.

The backlight control section 105 receives the backlight control value K to each sub-region decided by the backlight control value deciding section 104 and controls the backlight 109 (light source block) belonging to the sub-region for lighting up the light source (LED). For adjusting the luminance of the light source, control is conducted, for example, by PWM (pulse width modulation) or amplitude modulation. In a case of PWM, the duty ratio is set to 100% for the maximum luminance and the duty ratio is changed in accordance with the backlight control value K. Further, it is preferred that the PWM frequency is higher than the frame frequency of the liquid crystal display device.

The backlight luminance calculation section 106 calculates the backlight luminance on the screen based on the backlight control value K to each of the sub-regions sent from the backlight control value deciding section 104. The backlight luminance Bsum at an arbitrary point A on the screen is determined by determining the luminance at the point A when the backlight (light source block) for each of sub-regions is lit one by one at the backlight control value K and taking the sum thereof.

The image correction section 107 corrects the video signals (gradation value) for each pixel based on the backlight luminance Bsum calculated by the backlight luminance calculation section 106. Assuming the backlight luminance when lit at 100% as Bmax, the backlight luminance as Bmax and the gradation value of the input video signal before correction as Pin, correction is conducted such that the gradation value Pout after the correction is:

Pout=Pin×Bmax/Bsum

The corrected video signals are sent to the liquid crystal panel 108.

In the liquid crystal panel 108, a gradation voltage control signal and a driving control signal are generated based on the input video signals after the correction, a gradation voltage is applied to the pixel circuit on the panel, and the transmittance of liquid crystals in the pixel region is controlled.

Respective elements of the in-region gradation detection section 102, the boundary gradation value detection section 103, the backlight control value deciding section 104, the backlight control section 105, the backlight luminance calculation section 106, and the image correction section 107 may, for example, be integrated into a unit backlight control circuit. For example, the backlight control circuit may be assembled into a central processing unit for controlling the entire liquid crystal display device in response to a user's instruction from a remote controller, or may be constructed with an IC or LSI used exclusively for backlight control separate from the CPU.

While not illustrated in FIG. 1, a spatial filter and a temporal filter may be inserted to the stage subsequent to the backlight control value deciding section 104. The spatial filter corrects the backlight control value K while considering the effect of leakage of light between adjacent sub-regions. That is, the spatial filter adds the amount of leakage of the light from peripheral regions by using a region coefficient showing the amount of leakage between adjacent sub-regions, and corrects the backlight control value from K to K′ such that the backlight luminance in the sub-region takes a desired value.

Further, the temporal filter is used for preventing flickering. The backlight control value K for each sub-region is held by several frames and compared with the backlight control value K′ of each region corrected by the spatial filter. In a case where the difference is larger than a predetermined threshold value, the control value is replaced with a value by slightly increasing or decreasing the held control value K instead of the corrected control value K′ as the backlight control value.

In this embodiment, the maximum gradation level Pb in the boundary portion 305 in the sub-region is determined together with the maximum gradation level Pa in the sub-region 201 and a higher gradation level is adopted as the maximum gradation level Pc. Accordingly, in a case where a pixel of high gradation level is present being localized to the boundary portion 305, the maximum gradation level Pc can be decided with preference. As a result, the deterioration of gradation in the boundary portion 305 can be decreased to suppress the accompanying luminance step.

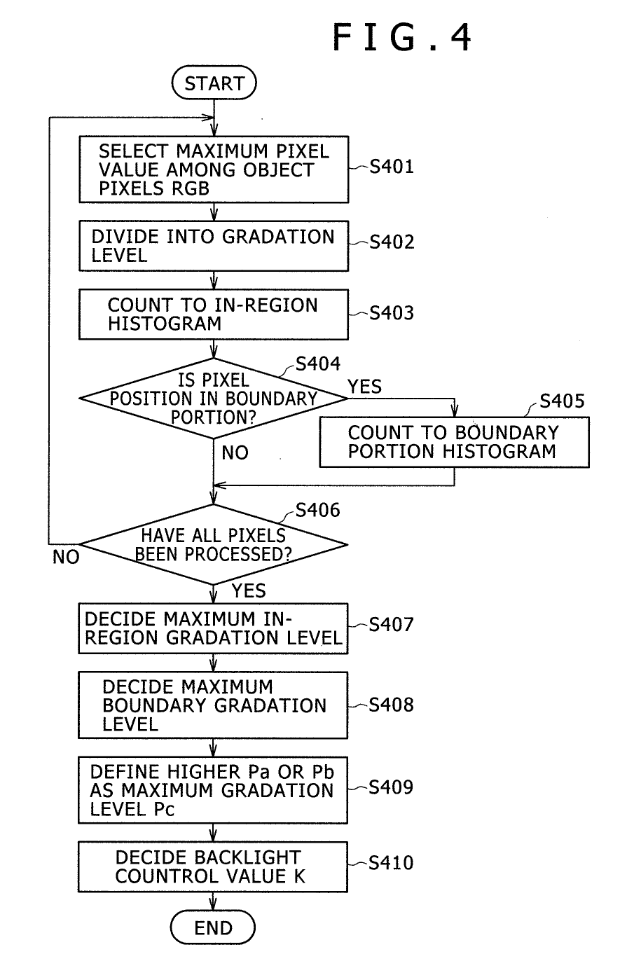

FIG. 4 is a flow chart showing the method of deciding the backlight control value in this embodiment. The backlight control value K is decided by the following procedures on every sub-region 201. At S401, a pixel value for an object pixel in the in-region 303 is detected based on the input image signal. In this step, a pixel value at the maximum gradation is selected among each of the pixel values for RGB. Then, the selected pixel value is subjected to gamma conversion conforming to the characteristics of the display. The gamma conversion may also be conducted in the steps after preparation of the histogram to be described later (S407 to S409).

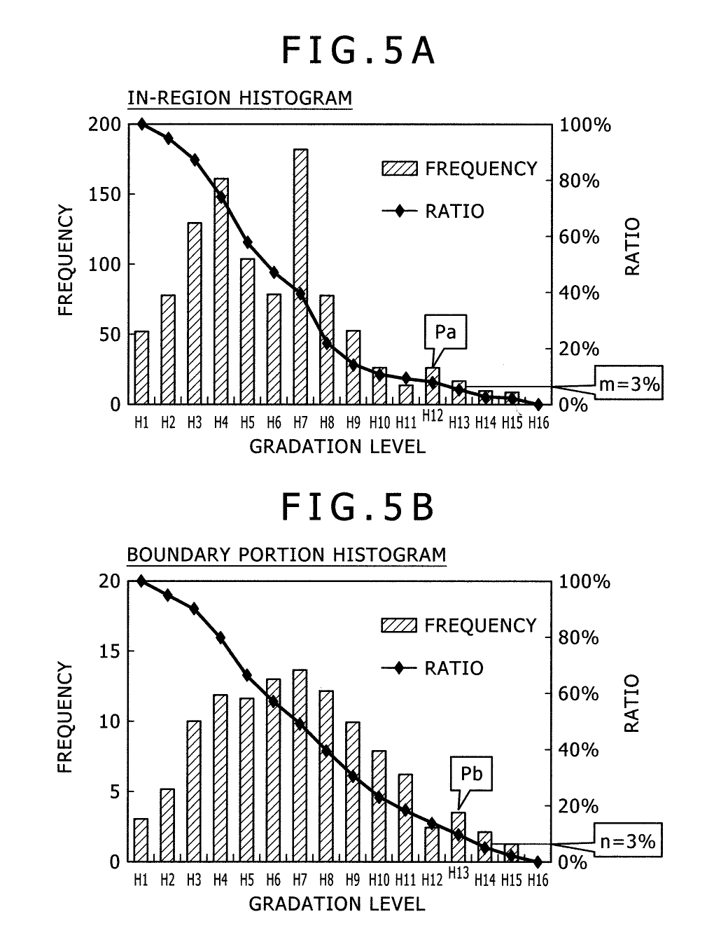

At S402, pixel values after the gamma conversion are divided into a plurality of predetermined gradation levels. For example, when the maximum gradation value is 255, levels of 16 steps are set at the gradation width 16 (H1 to H16 in FIG. 5A, FIG. 5B to be described later) and it is judged which level the value belongs to. At 403, they are counted as frequency values to the gradation level obtained at S402.

At S404, it is judged whether the object pixel belongs to the boundary portion 305 or not. If it belongs to the boundary portion 305, the process proceeds to S405 and, if it does not belong (that is, if it is the central portion 304), the process proceeds to S406. At S405, the pixel is counted as the frequency value to the gradation level obtained at S402. At S406, it is judged if the processing for all pixels in the in-region 303 has been completed or not. It has not yet been completed, the process returns to S401 and the processing for remaining object pixels is repeated. If it has been completed, the process proceeds to S407.

At S407, the maximum in-region gradation level Pa is decided with reference to the in-region histogram. In the in-region histogram, gradation levels for the pixels within the predetermined upper range (m %) from the brightest gradation level are removed and the brightest gradation level among the remaining gradation levels is determined as the maximum in-region gradation level Pa. At S408, the maximum boundary gradation level Pb is decided with reference to the boundary portion histogram. In the boundary portion histogram, the gradation levels for the pixels within a range (n %) of the predetermined upper range are removed from the brightest gradation level, and the brightest gradation level among the remaining gradation levels is determined as the maximum boundary gradation level Pb.

At S409, the maximum in-region gradation level Pa and the maximum boundary gradation level Pb are compared and a higher gradation level is defined as the maximum gradation level Pc in the sub-region. At S410, the ratio Pc/Pmax between the maximum gradation level Pc and the upper limit value Pmax of the gradation value is determined as the backlight control value K to the sub-region 201.

FIG. 5A and FIG. 5B are views showing examples of the prepared histograms. FIG. 5A is an example of an in-region histogram which shows the frequency to the gradation levels H1 to H16. Further, the ratio is shown as a cumulative value for the number of pixels present at each of the gradation levels starting from the brightest gradation level. For determining the maximum in-region gradation level Pa, gradation levels (H16 to H13) within a range where the ratio is in a predetermined range, for example, m=3% are removed. Then, among the remaining gradation levels, H12 which is the brightest gradation level is defined as the maximum in-region gradation level Pa.

On the other hand, FIG. 5B is an example of the boundary portion histogram and it shows the frequency and the ratio to the gradation levels H1 to H16 in the same manner as that in FIG. 5A. Since the number of pixels in the boundary portion is much less than the number of pixels in the entire region, the population parameter is smaller. For determining the maximum boundary gradation level Pb, the gradation levels in a range where the ratio is in a predetermined range, for example, n=3% (H16 to H14) are removed and H13 as the brightest gradation level among the remaining gradation levels is defined as the maximum boundary gradation level Pb.

In this case, the maximum in-region gradation level Pa is H12 and the maximum boundary gradation level Pb is H13, and H13 of the higher gradation level is adopted as the maximum gradation level Pc for the sub-region. In accordance therewith, the backlight control value K is decided as: K=Pc/Pmax=H13/H16=0.81.

The range (m %) for the pixels to be removed in the in-region histogram and the range (n %) for the pixels to be removed in the boundary portion histogram may be set properly in accordance with the permissible value for degradation of image quality, or the m value and the n value may be set in different ranges.

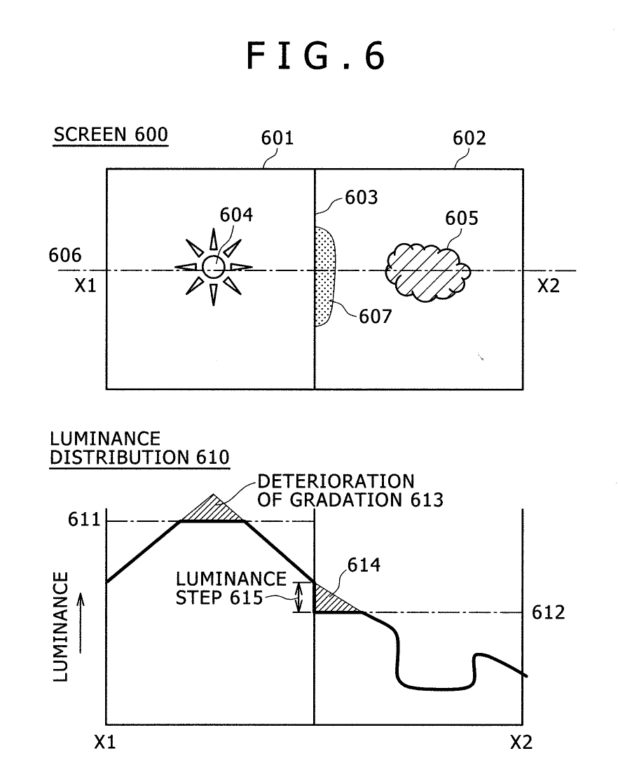

According to this embodiment, since the maximum gradation level Pc is decided by removing the levels within the predetermined range from the brightest gradation level, the power consumption of the backlight can be decreased remarkably. In this case, when a pixel of high gradation level is present in the boundary portion, the maximum gradation level Pc is decided with a priority being given thereto. Accordingly, the deterioration of gradation 614 in the boundary portion 603 as shown in FIG. 6 can be decreased to suppress the accompanying generation of the luminance step 615 and the shade portion 607.

### Second Embodiment

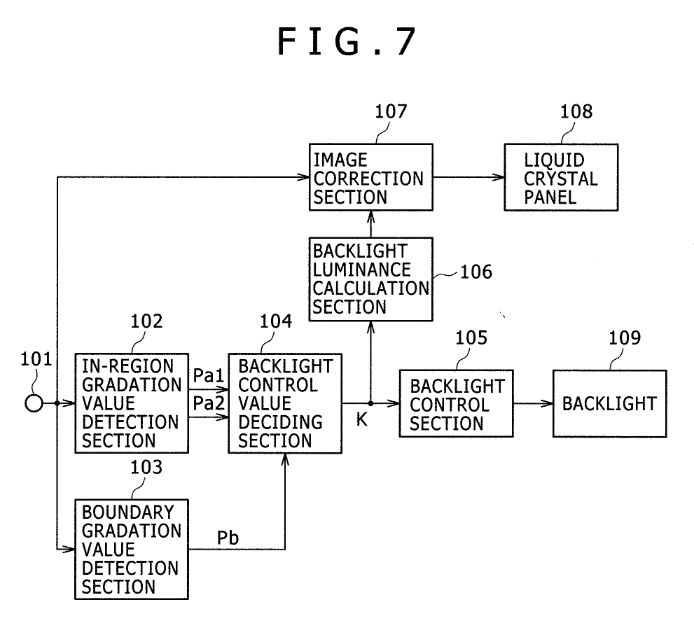

FIG. 7 is a block diagram showing a second embodiment of the liquid crystal display device according to the invention. The configuration of the embodiment is based on that of the first embodiment (FIG. 1) in which identical elements carry identical reference numerals. Description is to be made to a portion different from FIG. 1.

An in-region gradation value detection section 102 detects the gradation level of input video signals and prepares an in-level histogram for gradation levels based on the result of detection. Then, gradation levels for the pixels present in two predetermined ranges (m1%, m2%) are removed from the brightest gradation level in the sub-region 201 and the brightest gradation levels among the remaining gradation levels are determined as the two types of maximum in-region gradation levels Pa1, Pa2. When it is set as m1<m2, Pa1≧Pa2. It is set, for example, as m1=1% and m2=3%.

A boundary gradation value detection section 103 determines the maximum boundary gradation level Pb in the same manner as in FIG. 1. A backlight control value deciding section 104 receives the input of the two types of maximum in-region gradation levels Pa1, Pa2 determined by the in-region gradation value detection section 102 and selects one of the maximum in-region gradation levels Pa1, Pa2 based on the maximum boundary gradation level Pb inputted from the boundary gradation value detection section 103. That is, if Pb is higher than Pa2, Pa1 of higher gradation level is selected, whereas if Pb is lower than Pa2, Pa2 at the lower gradation level is selected as the maximum gradation level Pc.

According to this embodiment, when a pixel of high gradation level is present in the boundary portion, since the range to be removed from the upper portion of the histogram is narrowed (m1% is adopted), deterioration of gradation in the boundary portion can be decreased to suppress the accompanying generation of the luminance step.

### Third Embodiment

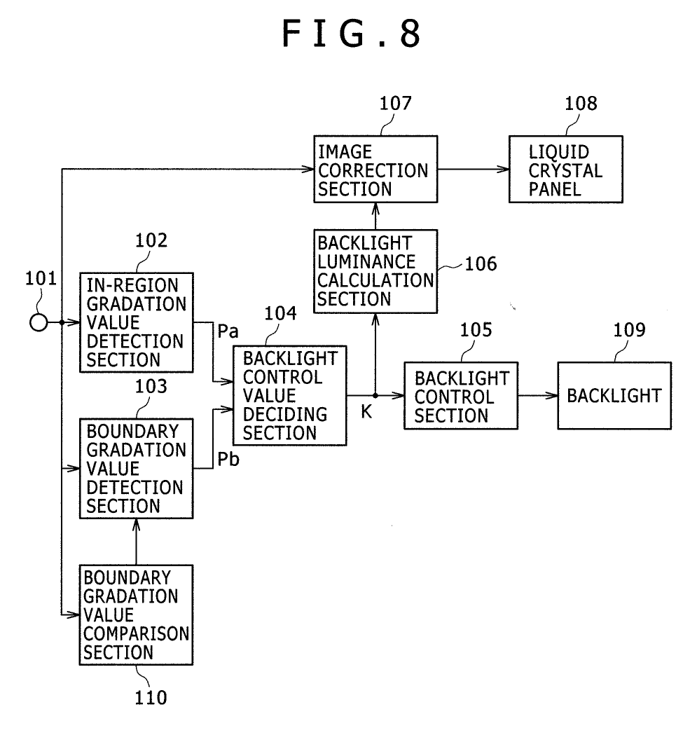

FIG. 8 is a block diagram showing a third embodiment of the liquid crystal display device according to the invention. The configuration of the embodiment is based on that of the first embodiment (FIG. 1) in which identical elements carry identical reference numerals. Description is to be made to a portion different from FIG. 1.

An in-region gradation detection section 102 determines the maximum in-region gradation level Pa in the same manner as in FIG. 1. A boundary gradation value detection section 103 determines the maximum boundary gradation level Pb in the same manner as in FIG. 1. An additionally disposed boundary gradation value comparison section 110 compares the gradation levels for the pixel groups belonging to the boundary portion 305 as an detection object of the boundary gradation value detection section 102 with the gradation level of the opposing pixel groups of adjacent sub-region, and sends a count instruction signal Sc to the boundary gradation value detection section 103 so as to remove pixels having a difference value larger than a threshold value from the detection object.

That is, with reference to FIG. 3, the gradation level (Q1, Q2, - - - ) for each of the pixels belonging to the boundary portion 305 are compared with the gradation levels (Q1′, Q2′, - - - ) for each of the pixels at the opposing positions in the adjacent sub-region respectively. When the difference of the gradation levels |Q1-Q1′|, |Q2-Q2′| is less than the threshold value, the count instruction signal Sc is turned ON (execution), and when this is larger than the threshold value, the count instruction signal Sc is turned OFF (not-execution). The boundary gradation value detection section 103 executes the counting operation to the boundary portion histogram in accordance with the instruction signal Sc. The threshold value is set such that it is, for example, 3% or less of a dynamic range (difference between the upper limit value and the lower limit value) of the gradation level.

According to this embodiment, the boundary gradation value detection section 103 conducts counting to the boundary portion histogram only for the pixels on both sides of the boundary line in which the gradation levels are close to each other.

Since the luminance step tends to be conspicuous in a case where the luminance on both sides of the boundary are close to each other, this can provide an effect of suppressing the generation of the luminance step more reliably.

In the description for the preferred embodiments of the invention described above, the maximum gradation level Pa for the entire inside of the sub-region and the maximum gradation level for at the boundary portion of the sub-region with the sub-region adjacent therewith, the invention is not restricted thereto. For example, the gradation level for the boundary portion of the sub-region and the maximum gradation level for the central portion except for the boundary portion may be determined. Further, a histogram for the entire inside of the sub-region may be determined and the maximum gradation level for the boundary portion may be determined by removing the histogram for the central portion therefrom. That is, any method may be used so long as it is possible to determine the maximum gradation level when a sub-region is taken entirely (that is, central portion except for the boundary portion or the entire sub-region including the central portion) and the maximum gradation level in the boundary portion of the sub-region.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such charges and modifications that fall within the ambit of the appended claims.

What is claimed is:

1. A liquid crystal display device having a liquid crystal panel for controlling the transmittance of pixels in accordance with the gradation level of input video signals and a backlight for illuminating the liquid crystal panel at the back thereof, in which
the liquid crystal panel is divided for the pixel on the panel into sub-regions comprising a plurality of pixel groups and the backlight includes a plurality of light source blocks corresponding to the sub-regions and the light source blocks are controlled individually by a backlight control circuit, and the control circuit
determines in each of the sub-regions, a first maximum gradation level from the input video signals in the boundary portion with an adjacent sub-region and a second maximum gradation level of the input video signals in the portion other than the boundary portion or the sub-region, and
calculates a control data for each of the light source blocks by using a higher one of the first maximum gradation level and the second maximum gradation level, and controls the brightness of each of the light source blocks individually.

2. The liquid crystal display device according to claim 1, wherein each of the first and the second maximum gradation levels are determined respectively by removing the maximum gradation level of the pixels within the predetermined upper range in the boundary portion and the portion other than the boundary portion or the sub-region.

3. A liquid crystal display device having a liquid crystal panel for controlling the transmittance of pixels in accordance with the gradation level of input video signals and a backlight for illuminating the liquid crystal panel at the back thereto, in which
the liquid crystal panel is divided for the pixels on the panel into sub-regions comprising a plurality of pixel groups, and the backlight includes a plurality of light source blocks corresponding to the sub-regions and has;
an in-region gradation value detection section which detects the gradation level of input video signals on every sub-region, removes gradation levels of pixels within a predetermined upper range (m %) from the brightest gradation level in the sub-region and detects the maximum in-region gradation level Pa,
a boundary gradation value detection section which removes gradation levels of pixels within a predetermined upper range (n %) from the brightest gradation level and detects the maximum boundary gradation level Pb for the pixel groups belonging to the region boundary portion in the sub-region,
a backlight control value deciding section which selects higher one of the in-region maximum gradation level Pa and the maximum boundary gradation level Pb as a maximum gradation level Pc for the sub-region, and decides the backlight control value K based on the ratio between the maximum gradation level Pc and the upper limit value Pmax of the gradation level, and
a backlight control section which controls lighting at a backlight luminance based on the backlight control value K to the light source block for illuminating sub-region.

4. A liquid crystal display device having a liquid crystal panel for controlling the transmittance of pixels in accordance with gradation levels of input video signals and a backlight for illuminating the liquid crystal panel at the back, in which
the liquid crystal panel is divided for the pixels on the panel into sub-regions comprising a plurality of pixel groups and the backlight includes a plurality of light source blocks corresponding to the sub-region and has;
an in-region gradation value detection section which detects the gradation levels of the input video signals on every sub-region, removes the gradation levels of pixels within two types of predetermined ranges (m1%, m2%) from the brightest gradation level in the sub-region and detects two types of in-region maximum gradation levels Pa1, Pa2,
a boundary gradation value detection section which removes gradation levels of pixels within a predetermined upper range (n %) from the brightest gradation level for the group of pixels belonging to the region boundary portion in the sub-region and detects the maximum boundary gradation level Pb,
a backlight control value deciding section which selects higher one of the maximum in-region gradation levels Pa1, Pa2 as the maximum gradation level Pc of the sub-region based on the maximum boundary gradation level Pb and decides the backlight control value K based on the ratio between the maximum gradation level Pc and the upper limit value Pmax of the gradation level, and
a backlight control section which controls lighting at a backlight luminance based on the backlight control value K to the light source block for illuminating the sub-region.

5. The liquid crystal display device according to claim 3, having a boundary gradation value comparison section which compares the gradation level for the pixel groups belonging to the region boundary portion as an detection object of the boundary gradation value detection portion with the gradation level for the opposing pixel groups in the adjacent sub-region, and removes pixels having a difference value larger than a threshold value from the detection object.

6. A method of controlling a backlight of a liquid crystal display device having a backlight for illuminating the liquid crystal panel at the back thereof, in which
the liquid crystal panel is divided for the pixels on the panel is divided for the pixels on the panel into sub-regions comprising a plurality of pixel groups, and the backlight has a plurality of light source blocks corresponding to the sub-regions, the method including;
detecting gradation levels of input video signals on every sub-region, removing the gradation levels for pixels within a predetermined upper range (m %) from the brightest gradation level in the sub-regions, and detecting the in-region maximum gradation level Pa,
removing gradation levels for the pixels within a predetermined upper range (n %) from the brightest gradation level for the pixel groups belonging to the region boundary portion in the sub-region and detecting the maximum boundary gradation level Pb,
selecting a higher one of the maximum in-region gradation level Pa and the maximum boundary gradation level Pb as the maximum gradation level Pc in the region,
deciding the backlight control value K based on the ratio between the maximum gradation level Pc and the upper limit value Pmax of the gradation level, and
controlling lighting at a backlight luminance based on the backlight control value K to the light source block for illuminates the sub-region.

7. A method of controlling the backlight of a liquid crystal display device having a backlight for illuminating a liquid crystal panel at the back thereof, in which
the liquid crystal panel is divided for the pixels on the panel into sub-regions comprising a plurality of pixel groups and the backlight has a plurality of light source blocks corresponding to the sub-regions, the method including;
detecting gradation levels of input video signals on every sub-region, removing the gradation levels for the pixels within two types of predetermined ranges (m1%, m2%) from the brightest gradation level in the sub-region and detecting two types of maximum in-region gradation levels Pa1, Pa2,
removing gradation levels for the pixels within a predetermined upper range (n %) from the brightest gradation level for the pixel groups belonging to the region boundary portion in the sub-region, and detecting the maximum boundary gradation level Pb,
selecting higher one of the maximum in-region gradation levels Pa1, Pa2 as the maximum gradation level Pc in the sub-region based on the maximum boundary gradation level Pb, and deciding the backlight control value K based on the ratio between the maximum gradation level Pc and the upper limit value Pmax of the gradation level, and
controlling lighting at a backlight luminance based on the backlight control value K to the light source block for illuminating the sub-region.

8. The backlight controlling method according to claim 6, wherein, the method includes
comparing the gradation level of pixel groups belonging to the region boundary portion with the gradation level of opposing pixel groups of an adjacent sub-region upon detecting the maximum boundary gradation level Pb, and removing pixels having difference value greater than a threshold value from the detection object.
